(19) United States
(12) Patent Application Publication
(10) Pub. No.: US 2012/0212830 A1
(43) Pub. Date: Aug. 23, 2012

(54) NONPOLARIZING BEAM SPLITTER

(75) Inventors: Stefan MEWES, Bovenden (DE); Stefan MEINING, Uslar (DE)

(73) Assignee: Qioptiq Photonics GmbH, Gottingen (DE)

(21) Appl. No.: 13/401,666

(22) Filed: Feb. 21, 2012

(30) Foreign Application Priority Data
Feb. 23, 2011 (DE) 10 2011 02 155.2

(51) Int. Cl. G02B 27/14

(52) U.S. Cl. 359/629

(57) ABSTRACT

Nonpolarizing beam splitter has at least one substrate, to which a partially reflective coating having a plurality of layers is applied. The layer sequence of the coating includes at least one metal layer, at least two first refractive layers made of a high or medium refractive index dielectric material, and at least two second refractive layers made of a low or medium refractive index dielectric material.

### CROSS-REFERENCE TO RELATED APPLICATIONS

This application claims the priority of German application no. 10 2011 012 155.2, filed Feb. 23, 2011, and which is incorporated herein by reference.

### FIELD OF THE INVENTION

The invention relates to a nonpolarizing beam splitter. More particularly, the invention relates to a nonpolarizing beam splitter having at least one substrate to which a partially reflective coating having a plurality of layers is applied, and the plurality of layers includes at least a first and a second refractive layer having respective refraction indices.

### BACKGROUND OF THE INVENTION

These types of beam splitters are generally known, and include at least one substrate to which a partially reflective coating having a plurality of layers is applied.

Such beam splitters are used, for example, in conjunction with an optical examination of components, using radiation in the UV range, for example for the examination of wafers.

In particular for the examination of wafers, there are currently two types of applications. In the first type, wafers undergo a surface inspection using light having a low bandwidth. In the second type, the surface inspection is carried out in the broadband range, in a wavelength range between UV and near infrared (NIR).

From U.S. Pat. No. 4,367,921 a nonpolarizing beam splitter is known which has a specialized layered structure comprising a metal layer in addition to a plurality of layers having high and low indices of refraction.

Similar nonpolarizing beam splitters are also known from JP 60 113 203 A and JP 61 011 701 A.

From U.S. Pat. No. 5,179,471 a spectrally selective mirror and a method for producing same are known.

### OBJECTS AND SUMMARY OF THE INVENTION

An object of the invention is to provide a nonpolarizing beam splitter which is usable in a broad wavelength range and whose function is independent of the polarization of the radiation used, and in which the absorption, which changes over the wavelength range, is at least partially compensated for.

This and other objects are achieved by the invention set forth herein.

In sum, the invention includes a nonpolarizing beam splitter including:
a) at least one substrate to which a partially reflective coating having a plurality of layers is applied; and
b) a layer sequence of the plurality of layers of the coating that includes:
   i) at least one metal layer;
   ii) at least two first refractive layers made of one of a high and a medium refractive index dielectric material; and
   iii) at least two second refractive layers made of one of a low and a medium refractive index dielectric material.

The invention likewise includes that a layer sequence of the coating has
at least one metal layer,
at least two first refractive layers made of a high or medium refractive index dielectric material, and
at least two second refractive layers made of a low or medium refractive index dielectric material.

The invention thus provides a coating having an at least five-layer structure in which, for example and in particular, the transmission and reflection values do not change in a wavelength range from 250 nm to 800 nm, the transmission and reflection properties being independent of the polarization of the incident radiation.

According to the invention, a material having a low index of refraction is understood to mean a material having an index of refraction n_{d}<1.5. For a material having a medium index of refraction within the meaning of the invention, 1.5 n_{d}<1.8. Within the meaning of the invention, a material having a high index of refraction has an index of refraction n_{d}>1.8.

It has surprisingly been shown that particularly favorable properties may be obtained when, with regard to the material and/or the thickness of the layers, the layer sequence is symmetrical with respect to the metal layer.

One advantageous further embodiment of the invention provides that the thickness of the metal layer is about 1-30 nm.

Other advantageous further embodiments of the invention provide that the thickness of the first refractive layers in each case is about 1-200 nm, preferably about 40-70 nm, and/or that the thickness of the second refractive layers in each case is about 1-200 nm, preferably about 40-70 nm.

Another advantageous further embodiment of the invention provides that at least one of the first refractive layers and/or at least one of the second refractive layers contains fluoridic material and/or oxidic material, or is made of one or more of such materials.

According to another advantageous further embodiment of the invention, the fluoridic or oxidic material in particular of the first refractive layers is or contains LaF₃ and/or GdF₃ and/or Al₂O₃ and/or HfO₂ and/or NdF₃ and/or CeF₃.

With regard to the second refractive layers, another advantageous further embodiment of the invention provides that the fluoridic or oxidic material in particular of the second refractive layers is or contains SiO₂ and/or AlF₃ and/or MgF₂ and/or BaF₂ and/or Na₃AlF₆ and/or Na₅Al₃F₁₄ and/or LaF₃ and/or GdF₃ and/or Al₂O₃ and/or NdF₃ and/or CeF₃.

Another advantageous further embodiment of the invention provides that the beam splitter is configured for function in a wavelength range of 175 to 1300 nm, in particular 190 to 900 nm, preferably 250 to 800 nm, and that in this wavelength range the ratio of reflection to transmission is 1 or about 1.

Another advantageous further embodiment of the invention provides that the reflection and transmission is 31%±9% in the wavelength range for which the beam splitter is configured.

Another advantageous further embodiment of the invention provides that the difference between the s-polarization and the p-polarization of the incident light is <10%, in particular <8%, in the wavelength range for which the beam splitter is configured.

For a nonpolarizing beam splitter, in addition to the reflection to transmission ratio, it is important that the values of the reflection and transmission for the s- and p-polarized light components do not differ too greatly, wherein for a nonpolarizing beam splitter, the second criterion is often the primary focus and is weighted more highly than a change in the values for reflection and transmission according to wavelength. According to the invention, the difference in the respective values for the reflection and transmission of the two polarization components of the light is <10% over the entire design wavelength range. According to the invention, in this range the transmission and reflection are in a corridor of <25%, respectively. For the 250-800 nm range, the difference between the polarization components is <8%, and the reflection and transmission are in a corridor of <18%.

According to the invention, it is possible for the coating to be provided on a single substrate or accommodated between two substrates, as provided in another further embodiment of the invention. If the coating is secured between two substrates, the substrates may be configured as prisms which together form a cube. The two substrates may be made of the same material, or of two different materials. They may be joined together without an air gap, for example by cementing, optical contact bonding, or immersion contacting, the coating being accommodated between the substrates.

The material of the substrate or substrates is selectable within a wide range, depending on the particular requirements. In this regard, one advantageous further embodiment of the invention provides that the substrate or at least one substrate is made of quartz glass and/or CaF₂ and/or MgF₂.

The invention is explained below with reference to the accompanying drawings, in which embodiments of a beam splitter according to the invention are illustrated in a highly schematic manner. All features described, illustrated in the drawings, and claimed in the patent claims constitute the subject matter of the invention, alone or in any given combination, independently of their combination in the patent claims or their dependencies, and independently of their description or illustration in the drawings.

### BRIEF DESCRIPTION OF THE DRAWINGS

FIG. 1 shows a highly schematic side view of a first embodiment of a beam splitter according to the invention;

FIG. 2 shows a layer sequence, not to scale, of a coating of the beam splitter according to the embodiment of FIG. 1;

FIG. 3 shows, in the same manner as FIG. 1, a second embodiment of a beam splitter according to the invention; and

FIG. 4 shows, in the same manner as FIG. 2, a layer sequence, not to scale, of a coating of the beam splitter according to the embodiment of FIG. 3.

### DETAILED DESCRIPTION OF THE INVENTION

Identical or corresponding components are provided with the same reference numerals in the figures of the drawing.

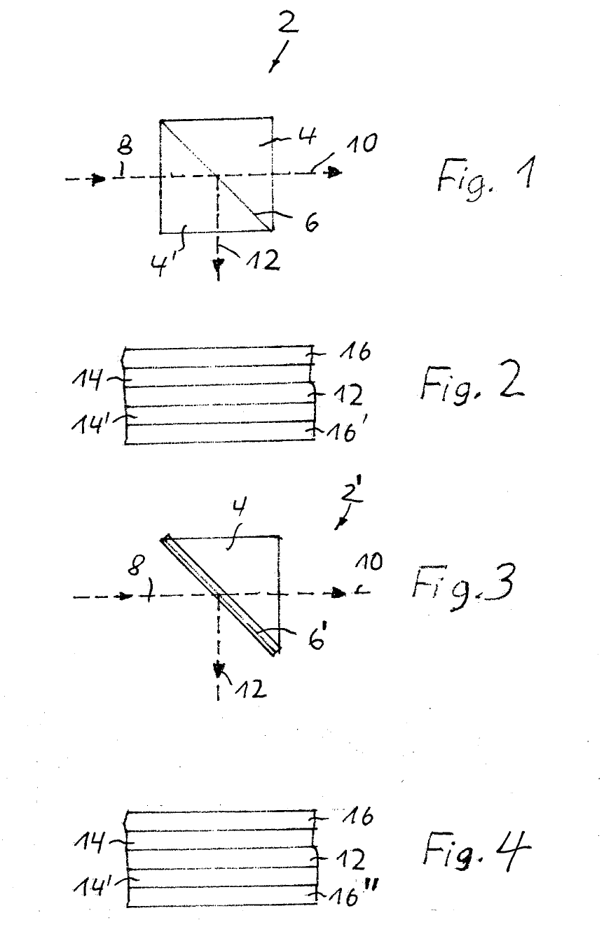

FIG. 1 illustrates a side view of a first embodiment of a nonpolarizing beam splitter 2 according to the invention which is composed of two prism-like substrates 4, 4′, between which a partially reflective coating 6 having a plurality of layers is accommodated. The function of the beam splitter 2 is to split an incident light beam 8 into two partial beams 10 and 11 by partial transmission and partial reflection. In other respects, the design and mode of operation of a nonpolarizing beam splitter are generally known to a person having ordinary skill in the art, and therefore are not explained in greater detail herein. In the illustrated embodiment, the substrates 4, 4′ are made of quartz glass and are securely joined together.

The structure of the coating 6 is explained in greater detail below with reference to FIG. 2.

FIG. 2 illustrates a cross section of the coating 6 (not to scale), which in the present embodiment comprises a metal layer 12, two first refractive layers 14, 14′, and two second refractive layers 16, 16′. In the illustrated embodiment, with regard to the material of the layers 14, 14′, 16, 16′ the layer sequence is symmetrically configured as a plane of symmetry with respect to the metal layer 12.

According to the invention, the first refractive layers are made of a high or medium refractive index dielectric material, while the second refractive layers are made of a low or medium refractive index dielectric material. In the illustrated embodiment, the material and layer thicknesses of the layers 12, 14, 14′, 16, 16′ are selected as follows:

| Layer | Material | Layer thickness |
|---|---|---|
| 16 | Al₂O₃ | 58.59 nm |
| 14 | HfO₂ | 46.22 nm |
| 12 | Al | 11.5 nm |
| 14′ | HfO₂ | 49.22 nm |
| 16′ | Al₂O₃ | 63.95 nm |

In the illustrated embodiment, the beam splitter 2 is configured for functioning in a wavelength range of 175-1200 nm, in particular 250-800 nm, and in this wavelength range the ratio of reflection to transmission being 1 or about 1. According to the invention, the phrase “configured for a wavelength range” is understood to mean that the transmission/reflection properties of the beam splitter 2 in this wavelength range do not change, or change only insignificantly. In the illustrated embodiment, the reflection and transmission are 31%±9% in the wavelength range for which the beam splitter 2 is configured. In the illustrated embodiment, in this wavelength range the difference between the s-polarization and the p-polarization of the incident light is <10%, in particular <8%.

FIG. 3 illustrates a second embodiment of a beam splitter 2′ according to the invention, which differs from the embodiment according to FIG. 1 in that a single substrate 4 is provided, on the outer surface of which a coating 6′ is applied. In the illustrated embodiment, the angle of incidence of the light on the coating 6′ is 45°. However, according to the invention it is also possible to use a different angle of incidence, for example 20° or 65°.

In the embodiment according to FIG. 3, in which the beam splitter 2′ has only one plane-parallel substrate 4, a different layer sequence is used which with regard to the material of the layers is no longer completely symmetrical with respect to the metal layer. The following layer sequence shown in FIG. 4 is used in the illustrated embodiment:

| Layer | Material | Layer thickness |
|---|---|---|
| 16 | Al₂O₃ | 99.93 nm |
| 14 | HfO₂ | 51.94 nm |
| 12 | Al | 9.81 nm |
| 14′ | HfO₂ | 40.3 nm |
| 16″ | MgF₂ | 73.07 nm |

For the splitting of the polarization components, here as well a value less than 10% results, and for reflection and transmission a corridor of less than 25% results.

The invention provides a nonpolarizing beam splitter which is suitable for function in a broad wavelength range, and whose mode of operation is independent of the polarization of the incident light. Furthermore, according to the invention the absorption, which changes over the wavelength range, is partially or completely compensated for.

What is claimed is:

1. A nonpolarizing beam splitter, comprising:
c) at least one substrate to which a partially reflective coating having a plurality of layers is applied; and
d) a layer sequence of the plurality of layers of the coating includes:
iv) at least one metal layer;
v) at least two first refractive layers made of one of a high and a medium refractive index dielectric material; and
iii) at least two second refractive layers made of one of a low and a medium refractive index dielectric material.

2. Beam splitter according to claim 1, wherein:
a) with regard to one of a material and a thickness of the plurality of layers, the layer sequence is symmetrical with respect to the metal layer.

3. Beam splitter according to claim 1, wherein:
a) a thickness of the metal layer is about 1-30 nm.

4. Beam splitter according to claim 1, wherein:
a) a thickness of the first refractive layers respectively is about 1-200 nm.

5. Beam splitter according to claim 1, wherein:
a) a thickness of the second refractive layers respectively is about 1-200 nm.

6. Beam splitter according to claim 1, wherein:
a) at least one of the at least two first refractive layers and at least one of the at least two second refractive layers includes at least one of fluoridic material and oxidic material.

7. Beam splitter according to claim 6, wherein:
a) the one of the fluoridic and oxidic material of the first refractive layers is one of LaF₃ and GdF₃ and Al₂O₃ and HfO₂ and NdF₃ and CeF₃.

8. Beam splitter according to claim 7, wherein:
a) the one of the fluoridic and oxidic material of the second refractive layers is one of SiO₂ and AlF₃ and MgF₂ and BaF₂ and Na₃AlF₆ and Na₅Al₃F₁₄ and LaF₃ and GdF₃ and Al₂O₃ and NdF₃ and CeF₃.

9. Beam splitter according to claim 1, wherein:
a) the beam splitter is configured for a wavelength range of 175 to 1300 nm, and in the wavelength range the ratio of reflection to transmission is one of 1 and about 1.

10. Beam splitter according to claim 9, wherein:
a) the reflection and transmission is <31%±9% in the wavelength range of 175 to 1300 nm.

11. Beam splitter according to claim 9, wherein:
a) in the wavelength range a difference between an s-polarization and a p-polarization of incident light is <10%.

12. Beam splitter according to claim 1, wherein:
a) the coating is provided on one of provided on a single substrate and provided between two substrates.

13. Beam splitter according to claim 1, wherein:
a) the at least one substrate is made of one of quartz glass and CaF₂ and MgF₂.

14. Beam splitter according to claim 11, wherein:
a) the difference between an s-polarization and a p-polarization of incident light is <8%.

15. Beam splitter according to claim 9, wherein:
a) the beam splitter is configured for a wavelength range of 250 to 800 nm.

16. Beam splitter according to claim 6, wherein:
a) the one of the fluoridic and oxidic material of the second refractive layers is one of SiO₂ and AlF₃ and MgF₂ and BaF₂ and Na₃AlF₆ and Na₅Al₃F₁₄ and LaF₃ and GdF₃ and Al₂O₃ and NdF₃ and CeF₃.

17. Beam splitter according to claim 5, wherein:
a) the thickness of the second refractive layers respectively is about 40-70 nm.

18. Beam splitter according to claim 4, wherein:
a) the thickness of the first refractive layers respectively is about 40-70 nm.
